(19) United States
(12) Patent Application Publication
(10) Pub. No.: US 2006/0225331 A1
(43) Pub. Date: Oct. 12, 2006

(54) Household organizer

(76) Inventor: Rodney E. Evans, Portsmouth, VA (US)

Correspondence Address: Duncan G. Byers, Suite 1200, 500 East Main Street, Norfolk, VA, 23510, US

(21) Appl. No.: 11/100,499

(22) Filed: Apr. 7, 2005

(51) Int. Cl. G09F 7/04

(52) U.S. Cl. 40/600

(57) ABSTRACT

A improved display board including folding portions with multiple regions for attaching and storing stationary and other items, the folding portions being multi-sided overlapping display areas for retaining various articles.

### BACKGROUND OF THE INVENTION

The present invention relates in general to display boards and organizers and more specifically relates to a display board for conveniently organizing the displayed contents. More particularly, the present invention relates to a system of flat rectangular panels of sheet metal or other material hinged together so that the panels fold upon themselves. The main panel is securely fixed to a surface while the secondary panels fold across the main panel for storage. The device can be affixed to various locations such as cabinet doors, regular doors, refrigerators, walls, etc.

The need to display selected material such as business cards, photographs, coupons, notes, and the like on a board or panel for viewing and storing the contents has resulted in a number of attempts to provide a board that satisfactorily displays and retains such materials. This is any age-old problem; papers are stored in kitchens on the surface of refrigerators using magnets. Such storage becomes cluttered, takes up space, is hard to review to find important information, and can be unattractive.

Previous patents have attempted to create additional surface area for organization, storage and retention of such material. For example, U.S. Pat. No. 6,364,126 to Enriquez teaches a display board that includes overlapping display sleeves and a region for recording notes. Such a device, however, simply creates more clutter and an inability to easily see to stored material, requiring additional time to leaf through the overlapping storage areas to find desired information.

U.S. Pat. No. 5 ,295,342 to Roche & Farber teaches a display panel that has a single storage surface. Such devices are limited to the available surface area of the surface to which the device is attached.

U.S. Pat. No. 5,755,338 to vom Braucke & vom Braucke teaches a bulletin board with a storage bin. Such a device is limited in the same manner as the U.S. Pat. No. 5,295,342 to a single storage surface area. The inclusion of a storage bin does not increase the available surface area and only provides storage compartments for loose items.

U.S. Pat. No. 3,150,296 is a portable metallic plate to which magnets may be attached or upon which notes may be written. In the same manner as the above devices, however, such a device is limited in the available surface area to the surface area to which the device is attached or displayed.

The primary object of the current invention is to overcome the limitations of surface area available for the posting and storage of notes, memorandum, and other information. The current invention expands the surface area available for the storage of such memos and information without regard to the limitation of the size of the surface area to which the device is attached. The current invention also allows for the stored/retained information to be viewed in large groups rather than in small bunches, thus making the location and retrieval of information faster and more efficient. It is a further object of the present invention to provide an arrangement to which standard and easily available magnets may be attached to retain notes and other information. The present invention may also be formed of heavy-duty materials for use in garages and other such environments. The addition of powerful and unobtrusive magnets on the mounting mounting surfaces will allow the present invention to be affixed to refrigerator surfaces and still accomplish the goal of eliminating clutter.

### SUMMARY OF THE PRESENT INVENTION

The present invention provides a device for storing notes, memoranda, recipes, and the like on available surfaces such as the door of a refrigerator, the inside surface of a cabinet, and/or walls. The device is expandable, providing a great deal more surface area than would normally be available given the surface area to which the device is mounted or attached. The device folds open so that a greater surface area may be achieved for affixing messages and the like as well as ease of reviewing the information stored in that manner, while at the same time folding away conveniently so that the device remains out of the way when not in use and/or to allow the device to be mounted on in the inside of cabinet doors and the like.

### BRIEF DESCRIPTION OF THE DRAWINGS

FIG. 1 is a perspective view of a folding organizer embodying the present invention;

FIG. 2 is a front view of the organizer of FIG. 1 as the device is closed for storage;

FIG. 3 is a front view of the organizer having four secondary modules which fold over the center, primary module.

### DESCRIPTION OF A PREFERRED EMBODIMENT

The present invention includes at least one primary module to which at least one secondary module is moveably attached, each module providing messaging and item storing functions primarily as a magnetic message board. Each module may also comprise other functions, such as a dry-erase board, a calendar, a cork board, etc. The main module may further consist of attachment means for attaching the device to the surface of a cabinet door, such attachment means being holes through which screws are affixed, adhesive, or the like.

The secondary panels are moveably attached to the primary module, such as with hinges, such that the secondary modules may be folded over the primary module for storage and folded outward to allow the user to attach memo items and review those already in place. Both the front and back surfaces of the secondary modules may be made of ferrous metal, allowing magnets to be used to affix messages and the like to both sides of the secondary module, thus doubling the usable surface area.

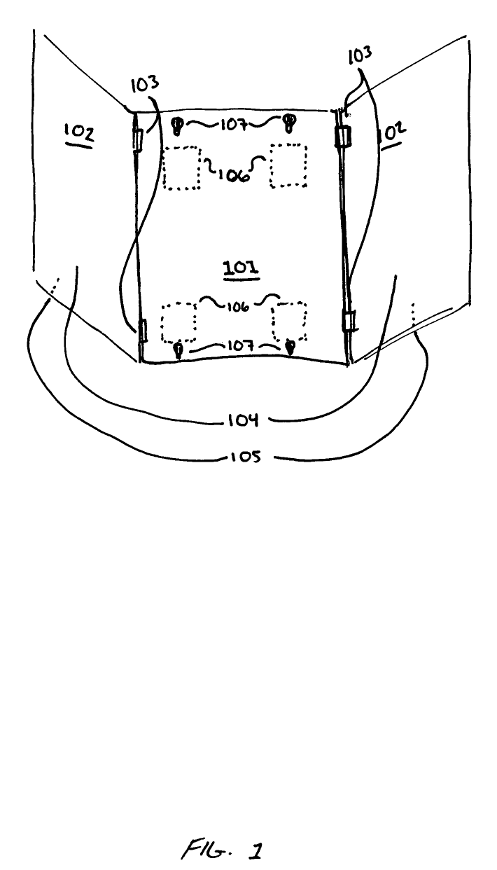

FIG. 1 shows the primary panel 101 and two secondary panels 102, where the secondary panels 102 are attached to the primary panel 101 via hinges 103. The hinges 103 allow the secondary panels 102 to be opened and closed. The secondary panels 102 have both an inner surface 104 and an outer surface 105. The inner surface 104 faces the exposed surface of the primary panel 101 when the device is closed, and the outer surface 105 faces away from the primary panel 101, allowing the outer surface 105 to be visible when the device is closed. The display board surface consists of the exposed surface of the primary panel as well as both sides of the secondary panels. The device may further comprise embedded magnets 106 for mounting the device to metal surfaces, as well as mounting holes 107 for permanently affixing the device to a surface through the use of screws and the like.

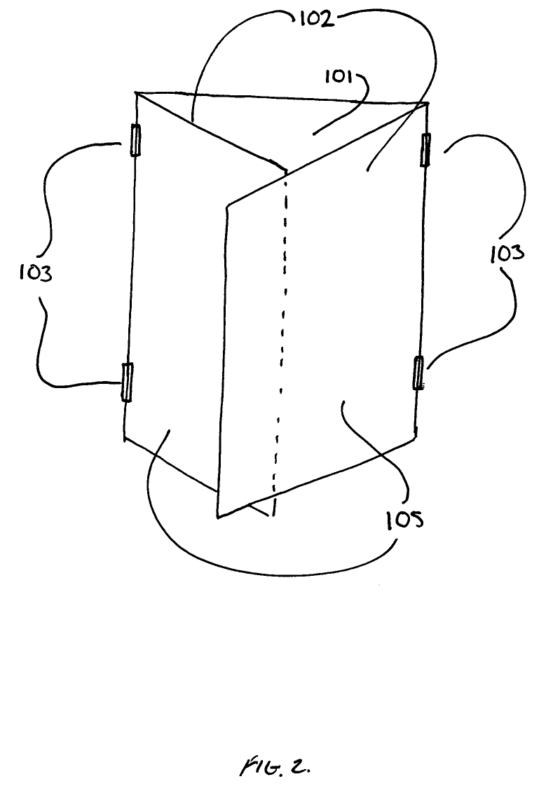

FIG. 2 shows the device with the secondary panels 102 partially folded closed over the primary panel 101. With the secondary panels 102 closed over the primary panel 101, the outer surface 105 of the secondary panels 102 becomes visible, allowing those surfaces to be viewed and/or utilized for affixing notes and the like using magnets. The closed position allows the device to take up a smaller surface area, such as on the inside of a cabinet door, so that the device can be stored out of the way or invisibly unless it is desired to be used.

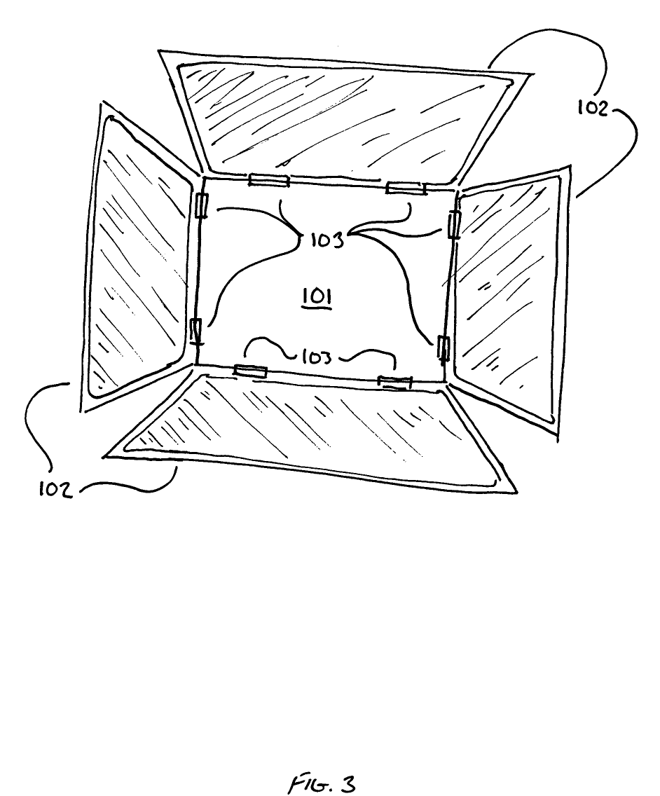

FIG. 3 shows an embodiment of the current invention with four secondary panels 102, those panels being moveably attached at hinges 103, and expanding the surface area of the primary panel 101 in four directions.

Although it is preferential that the panels be constructed of ferrous materials so that magnets may be attached to the surfaces of the panels, it will be obvious to one skilled in the art that other materials may be used to create the panels for different purposes, including cork board for attaching items, dry-erase surfaces for written notes, and the like. Further, the functional surface areas of the primary and secondary panels may be coated ferrous material such that the functional surfaces may be utilized as both surfaces for attaching magnets as well as erasable surfaces for writing notes and other information.

This invention has been described in connection with a preferred embodiment thereof, and it should be clear to one skilled in the art that modifications and changes therein may be made by one skilled in the art without departing from the spirit and scope of the invention. The details of the present invention as described are illustrative only, and do not limit the scope of the present invention as claimed below.

What is claimed is:

1. A message board with at least one primary panel and one or more secondary panels, said primary panel comprising a functional surface area; said secondary panels comprising one or more fuctional surface areas, and said secondary panels being moveably attached to said primary panel.

2. The message board of claim 1 wherein said message board secondary panels are moveably attached to said primary panel by hinges.

3. The message board of claim 1 wherein said message board further comprises magnets installed on the mounting surface side.

4. The message board of claim 1 wherein said functional surface areas comprise in part a ferrous material.

5. The message board of claim 1 wherein said function surface areas comprise in part an erasable coating.

6. The message board of claim 1 wherein said functional surface areas comprise in part a cork board.

7. The message board of claim 1 wherein said secondary panels comprise at least two functional surface areas.

8. The message board of claim 1 wherein said device further comprises embedded magnets.

9. The message board of claim 1 wherein said device further comprises mounting holes.

10. A message board comprising:
at least one primary panel, said primary panel comprising a functional surface area;
one or more secondary panels, said secondary panels comprising one or more functional surface areas and said secondary panels being moveably attached to said primary panel;
said one or more secondary panels are foldable over said primary panel wherein the said primary and secondary panel surface areas comprise one or more ferrous materials, erasable-materials, or cork board.

11. The message board of claim 10 wherein said primary panel surface area further comprises mounting means.

12. The message board of claim 11 wherein said mounting means is magnets or an equivalent.

13. The message board of claim 12 wherein said mounting means is screw holes or an equivalent.
